(19) United States
(12) Patent Application Publication
(10) Pub. No.: US 2013/0014848 A1
(43) Pub. Date: Jan. 17, 2013

(54) Apparatus for obstructing rats in sewage pipes

(71) Applicant: Gerard O'Reilly, Tel Aviv (IL)

(72) Inventor: Gerard O'Reilly, Tel Aviv (IL)

(21) Appl. No.: 13/135,780

(22) Filed: Jul. 15, 2011

(51) Int. Cl. F16L 55/00

(52) U.S. Cl. 138/103

(57) ABSTRACT

A barrier, installed in the sewage pipe and intended to prevent the penetration of rats, that comprises a main body shaped like a short hollow sleeve, a main obstructing plate, a secondary obstructing plate, a first locking tongue, and a second locking tongue; whereby the sleeve is shaped like a short hollow pipe with a flat top part; and whereby the main obstructing plate is shaped like an ellipse whose upper edge is truncated, forming a straight line, and which has a hole at the bottom beneath which are two protruding pins. A top pin and a bottom pin; and whereby the secondary obstructing plate is also shaped like an ellipse with a truncated upper edge, forming a straight line, and has a protruding pin near its bottom edge; and whereby the first and second locking tongues have the general shape of a rectangle; and whereby the main obstructing plate, the secondary obstructing plate, and the locking tongues are all attached to the flat top of the sleeve, from the inside, using hinges.

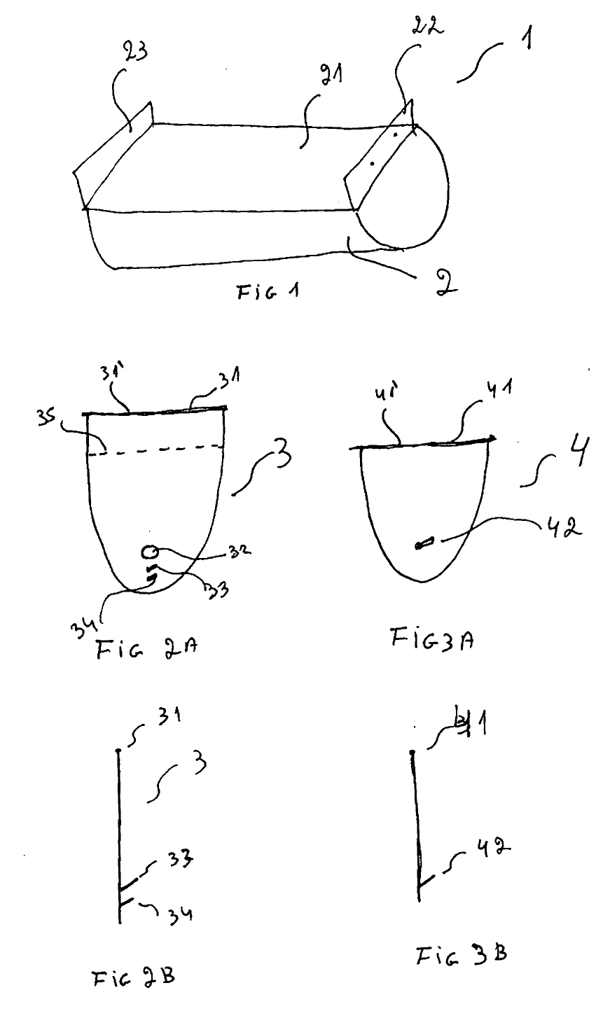

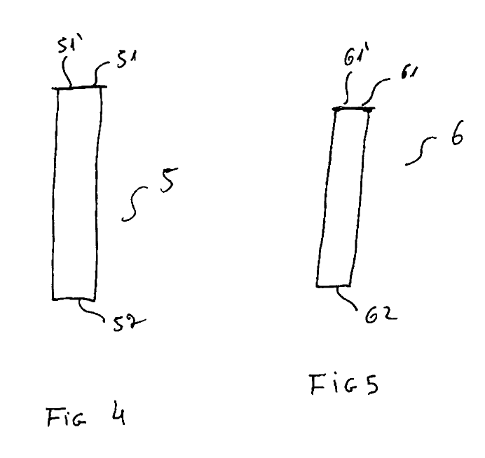

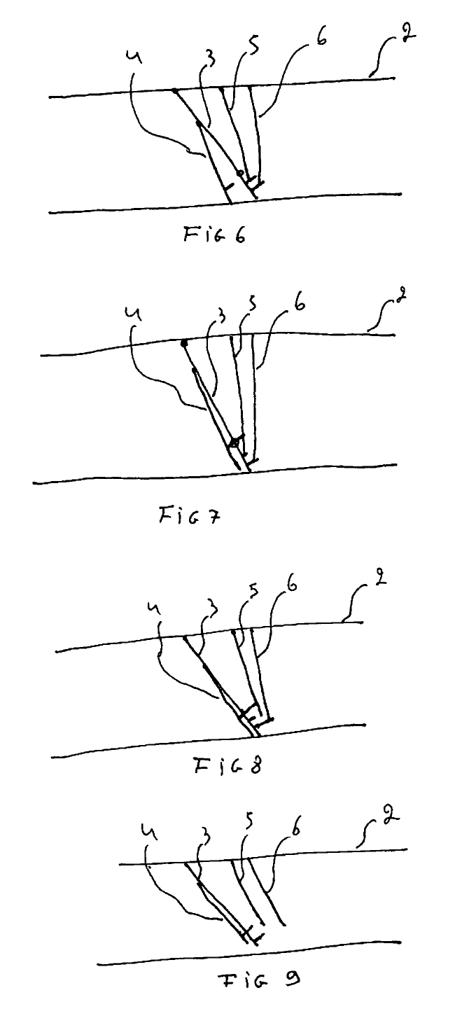

### TECHNICAL FIELD

The present invention refers to an apparatus designed to obstruct the passage of rats and other kinds of rodents (here in after “rats”) through sewage pipes.

### BACKGROUND ART

Many rats live in the sewage system, causing damage to the piping infrastructure and constituting a health hazard both by spreading disease and causing physical harm to humans. This problem occurs more intensely in sewage systems of ground floor houses, in which rats reach the toilets within the house, among other places, through the main sewage piping. The apparatus, subject of the present invention, offers a good and effective response to the aforementioned problem and is designed to prevent the penetration of rats from the main sewage system into the household sewage piping.

### THE INVENTION

The main objective of the present invention is to provide an apparatus that is installed within the sewage pipe and is designed to obstruct the penetration of rats from the main sewage system into the household sewage piping.

The present invention refers to a barrier (1) composed of a main body that is shaped like a short, hollow sleeve (2) (hereinafter referred to as “the sleeve”), a main obstructing plate (3), a secondary obstructing plate (4), a first locking tongue (5), and a second locking tongue (6). The barrier (1) components, including screws and hinges, can and should be made of a corrosion-resistant material such as stainless steel.

Drawing No. 1 presents a general view of the main body (2). The main body (2) has the general shape of a short, hollow sleeve (in a shape as a pipe). The top (21) of the sleeve (2) is flat, so as to enable the barrier (1) components to be attached effectively and easily to the sleeve (2). The optimal length of the sleeve can range between 10 cm. and 20 cm., although the invention may be implemented using other lengths, both shorter and longer and different diameters sleeves.

Drawing No. 2 depicts the main obstructing plate (3). The main obstructing plate (3) is shaped like an ellipse with a truncated upper edge (31), forming a straight upper edge. There is a hole (32) at the bottom of the main obstructing plate (3) with two protruding pins beneath it: A top pin (33) and a bottom pin (34). Drawing No. 2a presents a side view of the main obstructing plate (3).

Drawing No. 3 depicts the secondary obstructing plate (4). The secondary obstructing plate (4) is also shaped like an ellipse with a truncated upper edge (41), forming a straight upper edge. A protruding pin (42) is located near the bottom of the secondary obstructing plate (4). Drawing No. 3a presents a side view of the secondary obstructing plate (4).

The first locking tongue (5) is depicted in Drawing No. 4 and has the general shape of a rectangle. The second locking tongue (6) is depicted in Drawing No. 5 and also has the general shape of a rectangle.

The barrier (1) components are attached to the main sleeve (2) and are related to one another as follows:

The main obstructing plate (3): The main obstructing plate (3) is attached from the inside, by means of a hinge (31′) to the flat top (21) of the sleeve (2), such that the entire length of the upper edge (31) of the plate (3) is in contact with the flat top (21) of the sleeve (2). The width of the flat top (21) of the sleeve (2) corresponds to the width of the upper edge (31) of the main obstructing plate (3). The bottom edge of the main obstructing plate (3) reaches and rests on the bottom of the sleeve (2). The shape of the main obstructing plate (3) (i.e. ellipse) fits into the diagonal cross-section of the sleeve (2) such that the main obstructing plate (3) blocks the sleeve (2) in a slightly diagonal manner.

The secondary obstructing plate (4): In general, the secondary obstructing plate (4) is shorter than the main obstructing plate (3). The secondary obstructing plate (4) is connected to the main obstructing plate (3) by means of a hinge (41′), such that the upper edge (41) of the secondary obstructing plate (4) is attached along a line (35) that is parallel to, and lower than the upper edge (31) of the main obstructing plate (3). The two obstructing plates (3) (4) are connected so that their bottom edges almost completely overlap. The shape of the secondary obstructing plate (4) (i.e. ellipse) fits into the diagonal cross-section of the sleeve (2) such that the secondary obstructing plate (4) also blocks the sleeve (2), although when the bottom edge of the secondary obstructing plate (4) rests on the bottom of the sleeve (2), it is located slightly behind the contact point between the bottom edge of the main obstructing plate (3) and the bottom of the sleeve (2). For clarity of the explanation, we will refer to the right-hand side of the sleeve (2), as depicted in the drawings, as its front side.

The first locking tongue (5): The top edge (51) of the first locking tongue (5) is attached by means of a hinge (51′) to the middle of the flat top (21) of the pipe (2). The point at which the first locking tongue (5) is attached to the sleeve (2) is located slightly in front of the point at which the secondary obstructing plate (4) is attached to the flat top (21) of the sleeve (2). The length of the first locking tongue (5) is such that its bottom edge (52) touches the base of the bottom of the top pin (33). Thus, the rat cannot lift the main obstructing plate (3) since it is restricted by the first locking tongue (5).

The second locking tongue (6): The top edge (61) of the second locking tongue (6) is attached by means of a hinge (62′) to the middle of the flat top (21) of the sleeve (2). The point at which the second locking tongue (6) is attached to the sleeve (2) is located slightly in front of the point at which of the first locking tongue (5) is attached to the flat top (21) of the sleeve (2). The length of the second locking tongue (6) is such that its bottom edge (62) touches the base of the bottom of the bottom pin (34). Thus, the rat cannot lift the secondary obstructing plate (4) since it too is restricted by the second locking tongue (6).

The barrier (1) operates as follows: Drawing No. 6 depicts the barrier (1), including all of its components, in neutral position. When water arrives at the barrier [from the left-hand side of the sleeve (2)], it first causes the secondary obstructing plate (4) to rise so that the pin (42) at the bottom of the plate (4) is inserted into the hole (32) on the main obstructing plate (3) [Drawing No. 7], causing the first locking tongue (5) to rise, thus releasing the top pin (33) from its locking position [Drawing No. 8]. When the first locking tongue (5) rises, it causes the second locking tongue (6) to rise as well [Drawing No. 9], thus releasing the bottom pin (34) from its locking position and enabling the main obstructing plate (3) to rise. Water can now flow freely through the pipe. When the flow of water subsides, the two obstructing plates and two locking tongues descend and return to locked position.

It is noted that the top (21) of the sleeve (2) is flat mainly so as to enable the plates (3) (4) to be attached effectively to the sleeve (2) without leaving a gap that would enable the penetration of rats through the barrier. In addition, the two ends of the pipe should be equipped, on top, with protection plates (22) (23) designed to block possible penetration of rats over the sleeve (2).

The barrier (1) should be installed at outlets from sewage basins into underground sewage pipes. The dimensions of the barrier (1) and its components can and should be adjusted to the dimensions of the piping and the location on the pipe at which it is to be installed. The barrier, subject of the present invention, offers a good and effective response to the problem of the penetration and presence of rats in the pipe system between the house and the barrier, which is located en route to the main sewage system.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

Drawing No. 1 depicts the sleeve (2).

Drawings Nos. 2 and 2a depict the main obstructing plate (3) from the front and side, respectively.

Drawings Nos. 3 and 3a depict the secondary obstructing plate (4) from the front and side, respectively.

Drawing No. 4 depicts the first locking tongue (5).

Drawing No. 5 depicts the second locking tongue (6).

Drawings Nos. 6-9 depict the locking tongues and obstructing plates in various positions.

What is claimed is:

1. A barrier, installed in the sewage pipe and intended to prevent the penetration of rats, that comprises a main body shaped like a short hollow sleeve, a main obstructing plate, a secondary obstructing plate, a first locking tongue, and a second locking tongue; whereby the sleeve is shaped like a short hollow pipe with a flat top part; and whereby the main obstructing plate is shaped like an ellipse whose upper edge is truncated, forming a straight line, and which has a hole at the bottom beneath which are two protruding pins: A top pin and a bottom pin; and whereby the secondary obstructing plate is also shaped like an ellipse with a truncated upper edge, forming a straight line, and has a protruding pin near its bottom edge; and whereby the first and second locking tongues have the general shape of a rectangle; and whereby the main obstructing plate, the secondary obstructing plate, and the locking tongues are all attached to the flat top of the sleeve, from the inside, using hinges.

2. The barrier, mentioned in claim No. 1, whereby it includes only one locking tongue.
